(19) United States
(12) Patent Application Publication
(10) Pub. No.: US 2025/0377627 A1
(43) Pub. Date: Dec. 11, 2025

(54) FIXING SYSTEM AND IMAGE FORMING APPARATUS

(71) Applicant: FUJIFILM Business Innovation Corp., Tokyo (JP)

(72) Inventors: Yuta SHIMATATE, Kanagawa (JP); Shunsuke YAMASAKI, Kanagawa (JP); Yasuhisa GONDA, Kanagawa (JP); Tatsuro MATSUOKA, Kanagawa (JP); Kazunari ISHII, Kanagawa (JP); Chihiro TONE, Kanagawa (JP)

(73) Assignee: FUJIFILM Business Innovation Corp., Tokyo (JP)

(21) Appl. No.: 18/892,588

(22) Filed: Sep. 23, 2024

(30) Foreign Application Priority Data
Jun. 5, 2024 (JP) 2024-091294

(51) Int. Cl. G03G 21/20; G03G 15/20

(52) U.S. Cl. CPC G03G 21/206; G03G 15/2017; G03G 2221/1645

(57) ABSTRACT

A fixing system includes: a fixing device including a first rotating body that is heated by a heating unit and is rotated, and a second rotating body that is rotated while being in contact with an outer peripheral surface of the first rotating body to form a passage portion through which a recording medium on which a toner image is formed is to pass; and an exhaust device including a duct that allows a part of air present on an outlet side of the passage portion to flow such that the air is sucked in from a suction port, flows upward at least once, and is then discharged to an outside from a discharge port, and a fan that generates a force for causing air to be sucked into the duct and causing the sucked air to flow, in which the duct includes an opening portion that is provided at a position in a middle of a portion of the duct allowing the air to flow upward and takes in air from the outside of the duct, a protruding portion that protrudes into the duct from an inner wall surface portion facing the opening portion, and a collection portion that is provided at a position below the protruding portion and collects unnecessary matter generated inside the duct and falling down.

### CROSS-REFERENCE TO RELATED APPLICATIONS

This application is based on and claims priority under 35 USC 119 from Japanese Patent Application No. 2024-091294 filed Jun. 5, 2024.

### BACKGROUND

### (i) Technical Field

The present invention relates to a fixing system and an image forming apparatus.

### (ii) Related Art

JP5271926B (claim 1, and FIGS. 1 to 3) discloses an image forming apparatus including a fixing device that melts and fixes a toner image formed on a sheet.

JP5271926B (claim 1, and FIGS. 1 to 3) also discloses that the image forming apparatus includes an exhaust passage for exhausting air near the fixing device to the outside of a body of the image forming apparatus.

Further, JP5271926B (claim 1, and FIGS. 1 to 3) also discloses that the exhaust passage includes a first flow passage, a bent portion, and a second flow passage.

The first flow passage is a flow passage that is led to the outside of the body and extends along one outer surface of the body. The bent portion is a portion that is bent near a corner between the one outer surface and another outer surface orthogonal to the one outer surface and communicates with the first flow passage. The second flow passage is a flow passage that communicates with the bent portion and extends along the other outer surface.

Furthermore, JP5271926B (claim 1, and FIGS. 1 to 3) also discloses that the bent portion is provided with at least an air retention portion for retaining air present in the exhaust passage.

JP6708416B (claim 1, and FIGS. 4 to 6) discloses an image forming apparatus that includes an image forming unit, a transfer unit, a pair of rotating bodies, a duct, a filter, and a first fan.

The image forming unit is a part that forms an image using toner containing a release agent. The transfer unit is a part that transfers the image formed by the image forming unit to a recording material. A fixing unit is a part that heats the recording material transported from the transfer unit by sandwiching and transporting the recording material with a nip portion to fix the image to the recording material.

The duct is a duct which includes an air intake port for taking in air from a vicinity of the pair of rotating bodies and of which the air intake port is disposed between the transfer unit and the nip portion in a transport direction of the recording material. The filter is a filter that is made of electret fiber, is provided in the duct, and is used to collect fine particles caused by the release agent. The first fan is a fan that blows air from the duct to the outside of the apparatus to guide the air near the pair of rotating bodies to the filter.

Further, JP6708416B (claim 1, and FIGS. 4 to 6) also discloses that the image forming apparatus includes a second fan for blowing air outside the apparatus toward the filter to cool the filter.

JP2017-191227A (claim 1, and FIGS. 1 to 5) discloses an image forming apparatus that includes a duct, a heat source, and a fixing device.

The duct is a duct through which air flows. The heat source is to heat air flowing in the duct. The fixing device is a device that is disposed outside the duct and fixes a toner image to a recording medium.

Further, JP2017-191227A (claim 1, and FIGS. 1 to 5) also discloses that the duct includes a communication portion provided on a downstream side of the heat source, allowing the inside and outside of the duct to communicate with each other, and capable of sucking in airflow from the fixing device.

### SUMMARY

A fixing system including a fixing device and an exhaust device has, for example, the following problem.

Among these, the fixing device allows a recording medium on which a toner image is formed to pass through a passage portion between a first rotating body and a second rotating body to perform fixing. The exhaust device includes a duct that sucks in air present on an outlet side of the passage portion from a suction port, allows the air to flow upward at least once, and then discharges the air to the outside.

In the fixing system, unnecessary matter consisting of components contained in the air sucked into the duct may fall down from the duct.

Aspects of non-limiting embodiments of the present disclosure relate to a fixing system and an image forming apparatus that can prevent unnecessary matter from falling onto a recording medium passing through a passage portion of a fixing device from a suction port of a duct of an exhaust device.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a fixing system including: a fixing device including a first rotating body that is heated by a heating unit and is rotated, and a second rotating body that is rotated while being in contact with an outer peripheral surface of the first rotating body to form a passage portion through which a recording medium on which a toner image is formed is to pass; and an exhaust device including a duct that allows a part of air present on an outlet side of the passage portion to flow such that the air is sucked in from a suction port, flows upward at least once, and is then discharged to an outside from a discharge port, and a fan that generates a force for causing air to be sucked into the duct and causing the sucked air to flow, in which the duct includes an opening portion that is provided at a position in a middle of a portion of the duct allowing the air to flow upward and takes in air from the outside of the duct, a protruding portion that protrudes into the duct from an inner wall surface portion facing the opening portion, and a collection portion that is provided at a position below the protruding portion and collects unnecessary matter generated inside the duct and falling down.

### BRIEF DESCRIPTION OF THE DRAWINGS

Exemplary embodiment(s) of the present invention will be described in detail based on the following figures, wherein:

FIG. 1 is a schematic diagram showing an image forming apparatus according to a first exemplary embodiment;

FIG. 2 is a schematic diagram showing a fixing system according to the first exemplary embodiment;

FIG. 3 is a schematic perspective view of an exhaust device of the fixing system;

FIG. 4 is a schematic cross-sectional view of a major portion of a first duct of the exhaust device;

FIG. 5 is a schematic cross-sectional view showing a state of the first duct shown in FIG. 4 during exhaust;

FIG. 6 is a schematic cross-sectional view of a major portion of an exhaust device of a fixing system according to a second exemplary embodiment;

FIG. 7 is a schematic cross-sectional view showing a state of a first duct shown in FIG. 6 during exhaust;

FIG. 8 is a schematic cross-sectional view of a major portion of an exhaust device of a fixing system according to a third exemplary embodiment;

FIG. 9 is a schematic cross-sectional view showing a state of a first duct shown in FIG. 8 during exhaust;

FIG. 10 is a schematic diagram of a fixing system of a comparative example; and

FIG. 11 is a schematic cross-sectional view showing a state of a first duct of the fixing system shown in FIG. 10 during exhaust and the occurrence of a problem.

### DETAILED DESCRIPTION

Exemplary embodiments of the present invention will be described below.

### First Exemplary Embodiment

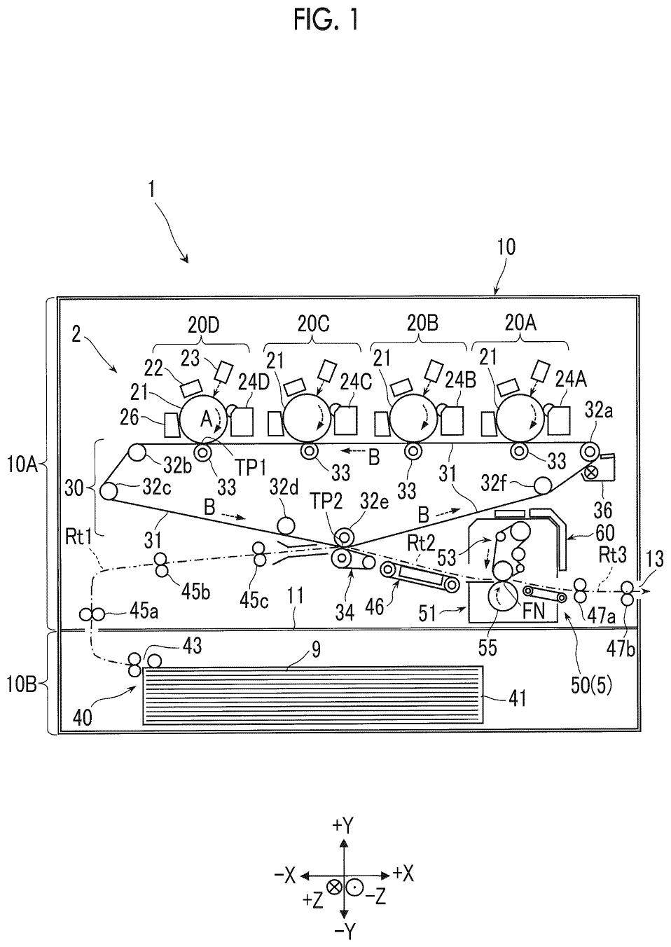

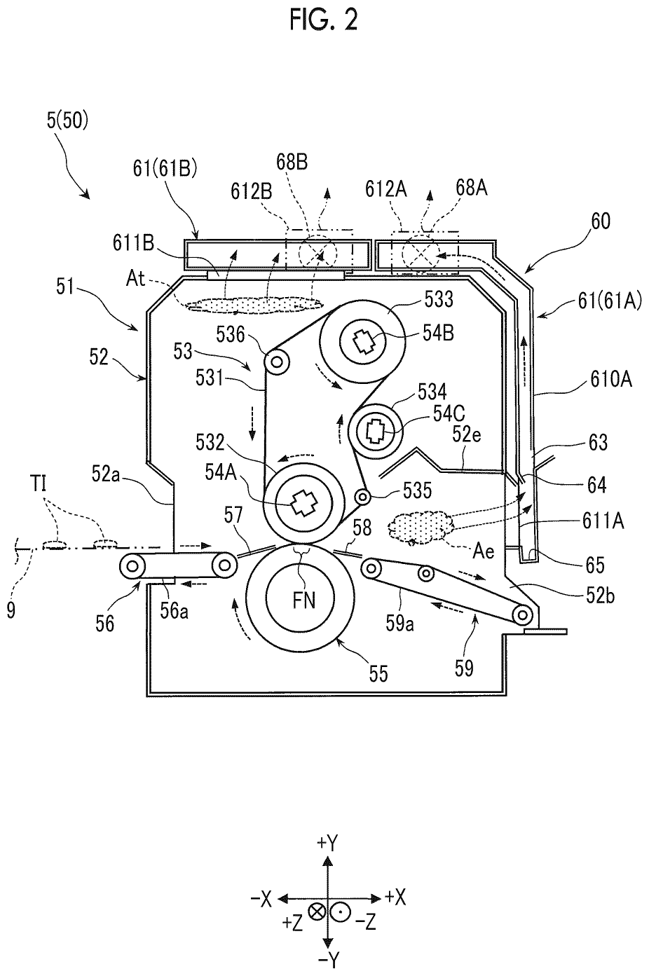

FIG. 1 is a schematic diagram showing an image forming apparatus according to a first exemplary embodiment of the present invention. FIG. 2 is a schematic diagram showing a fixing system according to the first exemplary embodiment.

In the present specification and the drawings, substantially identical components are denoted by identical reference numerals. Further, the repeated description of the identical components is omitted in the present specification.

An arrow +X shown in FIG. 1 and the like indicates a rightward direction in a case where the image forming apparatus 1 and the like are viewed from a front side, and an arrow -X indicates a leftward direction in that case. An arrow +Y shown in FIG. 1 and the like indicates an upward direction of the image forming apparatus 1 and the like, and an arrow −Y indicates a downward direction thereof. Reference character +Z shown in FIG. 1 and the like denotes a depth direction in a case where the image forming apparatus 1 and the like are viewed from the front side, and Reference character −Z denotes a front direction in that case.

Further, a symbol with “x” inside “○” in FIG. 1 and the like indicates a direction from a front side to a back side of the planes of the paper of the drawings. A symbol with “⋅”inside “○” in FIG. 1 and the like indicates a direction from the back side to the front side of the planes of the paper of the drawings.

### Image Forming Apparatus

An image forming unit 2, a medium feed section 40, a fixing unit 50, and the like are disposed inside a housing 10 of the image forming apparatus 1 according to the first exemplary embodiment.

Among these, the housing 10 is a structure that has an internal space and is formed in a predetermined shape.

Further, for example, the housing 10 is divided into an upper housing 10A and a lower housing 10B with a partition plate 11 as a boundary. The image forming unit 2, the fixing unit 50, and the like are disposed in the upper housing 10A. The medium feed section 40 and the like are disposed in the lower housing 10B.

### Image Forming Unit

The image forming unit 2 is a part that forms a toner image as an unfixed image on a recording medium 9.

The image forming unit 2 includes an imaging section 20, an intermediate transfer section 30, and a medium feed section 40.

The imaging section 20 is a part that forms a toner image obtained by developing a latent image corresponding to image information with a developer.

As shown in FIG. 1, the imaging section 20 of the first exemplary embodiment includes four imaging units 20A, 20B, 20C, and 20D.

The imaging units 20A, 20B, 20C, and 20D are units that employ an electrophotographic method. The imaging units 20A, 20B, 20C, and 20D form unfixed images, which are developed with developers having predetermined colors (A, B, C, and D), on photosensitive drums 21, respectively.

Examples of the predetermined colors (A, B, C, and D) include colors such as yellow, magenta, cyan, and black.

Further, in each of the imaging units 20A, 20B, 20C, and 20D, a charging device 22, an exposure device 23, a developing device 24, a drum cleaning device 26, and the like are disposed around the photosensitive drum 21.

Reference numerals of the charging device 22, the exposure device 23, and the drum cleaning device 26 are representatively shown only for the imaging unit 20D. Since the colors (A, B, C, and D) of the developers to be used are different from each other, the developing devices 24 are shown as the developing devices 24A, 24B, 24C, and 24D.

The intermediate transfer section 30 is a part that relays and transfers each of toner images, which are formed by the imaging units 20A, 20B, 20C, and 20D of the imaging section 20, onto a recording medium 9.

The intermediate transfer section 30 of the first exemplary embodiment includes an intermediate transfer belt 31, primary transfer devices 33, a secondary transfer device 34, a belt cleaning device 36, and the like.

The intermediate transfer belt 31 is an endless belt that can hold a toner image on an outer peripheral surface of the belt mainly with an electrostatic force and transport the toner image.

The intermediate transfer belt 31 is rotated while passing by the respective photosensitive drums 21 of the imaging units 20A, 20B, 20C, and 20D. Specifically, the intermediate transfer belt 31 is wound around a predetermined number of support rollers 32a, 32b, 32c, 32d, 32e, and 32f and is rotated in a direction indicated by an arrow B. Among these support rollers, the support roller 32a is a driving roller and the support roller 32e is a secondary transfer back roller.

The primary transfer device 33 is a device that primarily transfers each toner image formed on each photosensitive drum 21 onto the outer peripheral surface of the intermediate transfer belt 31. In the intermediate transfer section 30, a position where the primary transfer device 33 faces each photosensitive drum 21 with the intermediate transfer belt 31 interposed therebetween is a primary transfer position TP1.

A device using a primary transfer roller, which rotates in contact with the outer peripheral surface of the intermediate transfer belt 31 at the primary transfer position TP1, is applied as the primary transfer device 33. A predetermined primary transfer bias is supplied to the primary transfer roller from a power supply device (not shown).

The secondary transfer device 34 is a device that secondarily transfers the toner images primarily transferred to the outer peripheral surface of the intermediate transfer belt 31 onto one surface of a recording medium 9. In the intermediate transfer section 30, a position where the secondary transfer device 34 faces the support roller 32e with the intermediate transfer belt 31 interposed therebetween is a secondary transfer position TP2.

A device using a secondary transfer roller or a secondary transfer belt, which rotates in contact with the outer peripheral surface of the intermediate transfer belt 31 at the secondary transfer position TP2, is applied as the secondary transfer device 34. A predetermined secondary transfer bias is supplied to the secondary transfer roller or a roller, which supports the secondary transfer belt, from a power supply device (not shown). In the first exemplary embodiment, a device in which a secondary transfer belt is rotatably supported by two support rollers is employed as the secondary transfer device 34.

The medium feed section 40 is a part that stores recording mediums 9 on which images are to be formed and feeds the recording mediums 9 to a predetermined position of the image forming unit 2.

The predetermined position of the first exemplary embodiment is the secondary transfer position TP2 of the intermediate transfer section 30.

The medium feed section 40 includes a storage body 41 that stores a plurality of recording mediums 9, a sending device 43 that sends out the recording mediums 9 one by one from the storage body 41, and the like. A loading plate on which the recording mediums 9 are to be loaded is disposed in the storage body 41.

The recording medium 9 is a medium which is transported to the image forming unit 2, onto which a toner image is transferred, and on which the toner image can be held. A medium such as a sheet cut to a predetermined size is used as the recording medium 9.

A plurality of sets of the storage body 41 and the sending device 43 may be provided.

A medium transport passage Rt illustrated in FIG. 1 by a one-dot chain line is disposed in the housing 10.

The medium transport passage Rt includes a feed transport passage Rt1, a relay transport passage Rt2, a discharge transport passage Rt3, and the like.

The feed transport passage Rt1 is formed of a predetermined number of pairs of transport rollers 45a, 45b, and 45c, a transport guide member (not shown), and the like.

The relay transport passage Rt2 is formed of a suction-type belt transport device 46. The belt transport device 46 includes a suction device. In the belt transport device, a transport belt in which a plurality of suction holes are formed is wound around two support rollers and is rotated in a predetermined direction. The suction device sucks air from an inner peripheral surface side of the transport belt to attract the recording medium 9 to an outer peripheral surface of an upper surface side of the transport belt.

The discharge transport passage Rt3 is a transport passage that connects the fixing unit 50 and a discharge port 13. The discharge transport passage Rt3 is formed of a predetermined number of pairs of transport rollers 47a and 47b, a transport guide member (not shown), and the like. The discharge port 13 is an opening through which the recording medium 9 is carried out, and is provided at a predetermined position on one side surface of the housing 10.

The formation of the toner image on the recording medium 9 using the image forming unit 2 is performed as follows.

Here, a case where toner images are formed in all of the imaging units 20A, 20B, 20C, and 20D will be described.

First, in a case where a command to perform an image forming operation is received, the photosensitive drum 21 starts to rotate in a direction indicated by an arrow A in each of the imaging units 20A, 20B, 20C, and 20D of the imaging section 20.

Further, in the intermediate transfer section 30, the intermediate transfer belt 31 starts to rotate in the direction indicated by the arrow B in a case where the image forming operation is performed.

Subsequently, in each of the imaging units 20A, 20B, 20C, and 20D, the charging device 22 charges an outer peripheral surface of the photosensitive drum 21 to a predetermined surface potential.

After that, the respective exposure devices 23 performs image exposure of the respective color components, which are formed to correspond to image information, on the charged outer peripheral surfaces of the respective photosensitive drums 21. Accordingly, electrostatic latent images divided into predetermined color components (A, B, C, and D) are formed on the outer peripheral surfaces of the photosensitive drums 21, respectively.

The image information is input from an external connection device (not shown), such as an information terminal or a storage medium connected to the image forming apparatus 1.

Subsequently, the developing devices 24A, 24B, 24C, and 24D develop the electrostatic latent images, which are formed on the outer peripheral surfaces of the photosensitive drums 21, with developers having corresponding colors, respectively. Accordingly, toner images having the predetermined colors (A, B, C, and D) are formed on the outer peripheral surfaces of the photosensitive drums 21, respectively.

Subsequently, in each of the imaging units 20A, 20B, 20C, and 20D of the imaging section 20, the toner image formed on the photosensitive drum 21 is transferred to the intermediate transfer section 30.

Finally, in each of the imaging units 20A, 20B, 20C, and 20D, the drum cleaning device 26 cleans the outer peripheral surface of the photosensitive drum 21 from which the toner image has been transferred.

After the photosensitive drums 21 are cleaned, the imaging units 20A, 20B, 20C, and 20D of the imaging section 20 are prepared for the next imaging step.

On the other hand, in the intermediate transfer section 30, the primary transfer devices 33 sequentially primarily transfer the toner images, which are formed on the respective photosensitive drums 21, onto the outer peripheral surface of the intermediate transfer belt 31 that passes through the primary transfer positions TP1.

At this time, the intermediate transfer belt 31 transports the toner images, which are primarily transferred onto the outer peripheral surface thereof, up to the secondary transfer position TP2.

Further, in the medium feed section 40, the sending device 43 sends out a predetermined recording medium 9 from the storage body 41 toward the secondary transfer position TP2 of the intermediate transfer section 30 in accordance with a secondary transfer time. At this time, the recording medium 9 is transported to the secondary transfer position TP2 via the feed transport passage Rt1.

Subsequently, in the intermediate transfer section 30, the secondary transfer device 34 secondarily transfers the toner images from the outer peripheral surface of the intermediate transfer belt 31, which passes through the secondary transfer position TP2, onto the recording medium 9.

Finally, in the intermediate transfer section 30, the belt cleaning device 36 cleans the outer peripheral surface of the intermediate transfer belt 31 from which the toner images have been secondarily transferred.

In a case where the intermediate transfer belt 31 is cleaned, the intermediate transfer section 30 is prepared for the next transfer step.

The recording medium 9 onto which the toner images have been secondarily transferred by the intermediate transfer section 30 is transported to be introduced into the fixing unit 50 via the relay transport passage Rt2.

In the relay transport passage Rt2, the suction-type belt transport device 46 transports the recording medium 9 in a state where the recording medium 9 is sucked.

### Fixing Unit and Fixing System

The fixing unit 50 is a part that heats the unfixed toner images, which are transferred onto the recording medium 9, to fix the unfixed toner images to the recording medium 9.

As shown in FIGS. 1 and 2, the fixing unit 50 is formed of a fixing system 5 according to the first exemplary embodiment.

The fixing system 5 forming the fixing unit 50 is a system in which a heating-type fixing device 51 and an exhaust device 60 are combined.

### Fixing Device

In the fixing device 51, a first rotating body 53 including heating units 54A, 54B, and 54C, a second rotating body 55, and the like are disposed inside a fixing housing 52.

The fixing housing 52 is a heat-resistant structure that has an internal space and is formed in a predetermined shape. The fixing housing 52 is formed in a long shape extending in a direction (a direction denoted by −Z) perpendicular to the planes of the paper of FIG. 2 and the like.

An introduction port 52a through which the recording medium 9 is introduced and a discharge port 52b through which the recording medium 9 is discharged are formed in side surface portions of the fixing housing 52 facing each other. The introduction port 52a and the discharge port 52b are formed of openings that are formed in a shape long in the depth direction.

Further, an introduction device 56 and an introduction guide member 57 that introduce the recording medium 9 as an object to be fixed into a passage portion FN to be described later from the introduction port 52a are disposed in the fixing housing 52.

The introduction device 56 is a transport device in which a medium transport belt 56a is wound around two support rollers and is rotated in a direction indicated by a broken line with an arrow. The introduction guide member 57 is disposed between the introduction device 56 and a position in front of the passage portion FN.

Furthermore, a carry-out guide member 58 and a carry-out device 59 that carry out the recording medium 9, to which images have been fixed, to the discharge port 52b from a position on a discharge side of the passage portion FN to be described later are disposed in the fixing housing 52.

The carry-out guide member 58 is disposed between the position on the discharge side of the passage portion FN and the carry-out device 59. The carry-out device 59 is a transport device in which a medium transport belt 59a is wound around three support rollers and is rotated in a direction indicated by a broken line with an arrow.

Reference numeral 52e shown in FIG. 2 denotes a partition plate.

The first rotating body 53 is a rotating body that is heated while being rotated.

The first rotating body 53 of the first exemplary embodiment is a rotating body in which a fixing belt 531 is wound around a predetermined number of rollers and is rotated while being heated. The predetermined number of rollers are a first heating roller 532, a second heating roller 533, an external heating roller 534, support rollers 535 and 536, and the like.

The first rotating body 53 in which such a belt is rotated is a belt-shaped rotating body, so to speak.

The fixing belt 531 is a belt that performs fixing processing in a state where an outer peripheral surface of the belt is in contact with the unfixed toner images formed on the recording medium 9. The fixing belt 531 is formed as an endless belt.

The first heating roller 532 is a heating roller that is disposed at a position facing the second rotating body 55. The heating unit 54A is disposed in a hollow of a cylindrical roller body of the first heating roller 532, and the first heating roller 532 is heated by the heating unit 54A.

The first heating roller 532 is in contact with an inner peripheral surface of the fixing belt 531 and heats the fixing belt 531 from an inner peripheral surface side.

Further, the first heating roller 532 forms the passage portion FN to be described later between the first heating roller 532 and the second rotating body 55 with the fixing belt 531 interposed therebetween.

The second heating roller 533 is a heating roller that is disposed at a position spaced upward from the first heating roller 532. The heating unit 54B is disposed in a hollow of a cylindrical roller body of the second heating roller 533, and the second heating roller 533 is heated by the heating unit 54B.

The second heating roller 533 is in contact with the inner peripheral surface of the fixing belt 531 and heats the fixing belt 531 from the inner peripheral surface side.

The external heating roller 534 is a heating roller that is disposed at a position between the first heating roller 532 and the second heating roller 533. A heating unit 54C is disposed in a hollow of a cylindrical roller body of the external heating roller 534, and the external heating roller 534 is heated by the heating unit 54C.

The external heating roller 534 is in contact with an outer peripheral surface of the fixing belt 531 and heats the fixing belt 531 from an outer peripheral surface side.

Further, the external heating roller 534 applies tension to the fixing belt 531 from the outer peripheral surface side of the belt.

The support roller 535 is a roller that is disposed at a position between the first heating roller 532 and the external heating roller 534. The support roller 535 supports a portion of the fixing belt 531 having passed through the passage portion FN such that the portion of the fixing belt 531 passes through a position away from the first heating roller 532.

The support roller 536 is a disposition roller that is disposed at a position between the second heating roller 533 and the first heating roller 532. The support roller 536 supports the fixing belt 531 such that the fixing belt 531 passes through a position outside a straight line region connecting the second heating roller 533 and the first heating roller 532.

Further, the support roller 536 is formed as a meandering suppression roller that suppresses the meandering of the fixing belt 531. The meandering suppression roller is referred to as, for example, a steering roller.

All of the heating units 54A, 54B, and 54C are not particularly limited in terms of conditions, such as a heating type, as long as being capable of performing predetermined heating.

The second rotating body 55 is a rotating body that is rotated while being in contact with an outer peripheral surface of the first rotating body 53 to form the passage portion FN through which the recording medium 9 on which toner images TI are formed is to pass.

The passage portion FN may also be referred to as a fixing nip in which unfixed toner images are fitted together with the recording medium 9 and are fixed to the recording medium 9.

A cylindrical pressure roller is used as the second rotating body 55 of the first exemplary embodiment. The second rotating body 55 in which such a roller is rotated is a roller-shaped rotating body, so to speak.

Further, the pressure roller, which is the second rotating body 55, receives a pressure, which is applied from a pressure mechanism (not shown), via a support frame (not shown). For example, a spring mechanism or a cam mechanism is applied as the pressure mechanism.

Accordingly, the pressure roller, which is the second rotating body 55, is in contact with the first rotating body 53 with a predetermined pressure at the passage portion FN.

Furthermore, the pressure roller, which is the second rotating body 55, is adapted to receive rotational power from a rotary drive device (not shown) and to be rotationally driven in a direction indicated by an arrow.

In a case where the pressure roller, which is the second rotating body 55, is rotationally driven and passes through the passage portion FN, the pressure roller transmits the rotational power to the fixing belt 531 that is the first rotating body 53. Accordingly, the second rotating body 55 functions to rotate the fixing belt 531 in a direction indicated by an arrow.

The fixing of the toner images using the fixing device 51 is performed as follows.

First, in the fixing device 51, the pressure roller, which is the second rotating body 55, starts to rotate in the direction indicated by the arrow in a case where an operation, such as the image forming operation, is performed. Accordingly, the fixing belt 531, which is the first rotating body 53, receives the rotational power of the pressure roller and starts to rotate in the direction indicated by the arrow.

Further, the first heating roller 532, the second heating roller 533, and the external heating roller 534 start to be heated by the heating units 54A, 54B, and 54C, respectively. Accordingly, the fixing belt 531, which is the first rotating body 53, is heated to a predetermined temperature.

Subsequently, the recording medium 9 on which the toner images TI as the unfixed images are formed is introduced into the fixing device 51 via the relay transport passage Rt2. The recording medium 9 at this time is carried in from the introduction port 52a by the introduction device 56 or the like and is introduced into the passage portion FN.

In a case where the recording medium 9 passes through the passage portion FN, the fixing device 51 heats the toner images TI at a predetermined fixing temperature under pressure to fix the toner images TI to the recording medium 9.

Further, the fixing device 51 carries out the recording medium 9, to which the toner images have been fixed and which has passed through the passage portion FN, with the carry-out device 59 and the like and discharges the recording medium 9 from the discharge port 52b.

As described above, the fixing of the toner images by the fixing device 51 ends.

The recording medium 9 to which the toner images have been fixed is discharged from the discharge port 52b of the fixing housing 52 to a discharge storage part (not shown) via the discharge transport passage Rt3.

The discharge storage part is formed of, for example, a plate-like member including a storage surface.

### Exhaust Device

The exhaust device 60 is a device that discharges air inside the fixing housing 52 of the fixing device 51 to the outside.

The exhaust device 60 includes at least a duct 61 and a fan 68.

The exhaust device 60 of the first exemplary embodiment includes two ducts, which are a first duct 61A and a second duct 61B, as the duct 61. Further, the exhaust device 60 includes two fans, which are a first fan 68A and a second fan 68B, as the fans 68.

The first duct 61A is a duct that sucks a part of air Ae, which is present on an outlet side of the passage portion FN in the fixing housing 52, and allows the sucked air to flow therethrough. The outlet side of the passage portion FN is a side to which the recording medium 9 passes through the passage portion FN and is discharged.

The first duct 61A is formed as a duct allowing a part of the air Ae to flow such that a part of the air Ae is sucked in from a suction port 611A, flows upward once, and is then discharged from a discharge port 612A.

Further, the first duct 61A includes a duct body 610A that connects the suction port 611A and the discharge port 612A.

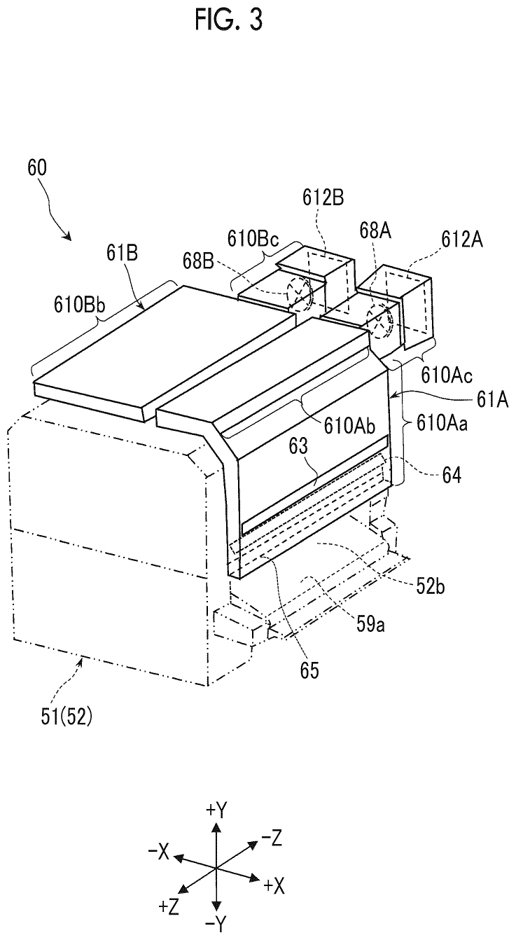

As shown in FIG. 3 and the like, the duct body 610A of the first exemplary embodiment is formed as a plate-like pipe that is shaped into a predetermined shape.

Further, the duct body 610A is formed in a shape that includes a standing portion 610Aa, a horizontal portion 610Ab, and a discharge portion 610Ac.

The standing portion 610Aa is a duct portion that is formed in a shape standing up substantially linearly in the upward direction (+Y). The suction port 611A is provided on a lower end side of the standing portion 610Aa. The standing portion 610Aa is disposed in a state of being close to a side surface portion of the fixing housing 52 in which the discharge port 52b is provided.

The horizontal portion 610Ab is a duct portion that is connected to an upper end portion of the standing portion 610Aa and is formed in a shape extending substantially horizontally. The horizontal portion 610Ab is disposed in a state of being close to a part of an upper surface of the fixing housing 52.

The discharge portion 610Ac is a duct portion formed in a shape extending from an exhaust end portion of the horizontal portion 610Ab to an exhaust port of a back portion of the housing 10, which is an exhaust destination. A discharge port 612A is provided at an end portion of the discharge portion 610Ac. A filter (not shown) that collects and removes dust and the like is installed in the discharge portion 610Ac.

The suction port 611A is provided at a portion of the standing portion 610Aa of the duct body 610A facing an upper portion of the discharge port 52b of the fixing housing 52. The suction port 611A is formed as a substantially rectangular opening that extends to be long along the depth direction (−Z) of the fixing housing 52.

The discharge port 612A is connected to an exhaust port (not shown) provided in a back portion or the like of the housing 10 of the image forming apparatus 1. The discharge port 612A is formed as an opening that is formed at an end portion of the discharge portion 610Ac of the duct body 610A to have a rectangular shape or the like.

The first fan 68A is a blower that generates a force for causing air to be sucked into the first duct 61A and causing the sucked air to flow.

The first fan 68A is installed, for example, in a middle portion of the discharge portion 610Ac of the duct body 610A. Any type of fan, such as an axial fan, a centrifugal fan, or a blower fan, is used as the first fan 68A.

On the other hand, the second duct 61B is a duct that mainly sucks a part of air At, which is present on an upper side in the fixing housing 52, and allows the sucked air to flow therethrough.

The second duct 61B is formed as a duct allowing a part of the air At to flow such that a part of the air At is sucked in from a suction port 611B and is then discharged from a discharge port 612B.

Further, the second duct 61B includes a duct body 610B that connects the suction port 611B and the discharge port 612B.

As shown in FIG. 3 and the like, the duct body 610B of the first exemplary embodiment is a plate-like pipe that is shaped into a predetermined shape.

Furthermore, the duct body 610B is formed in a shape that includes a horizontal portion 610Bb and a discharge portion 610Bc.

The horizontal portion 610Bb is a portion that is formed in a shape extending substantially horizontally on an upper surface portion of the fixing housing 52. The horizontal portion 610Bb is disposed in a state of being close to the remaining portion of the upper surface of the fixing housing 52.

The discharge portion 610Bc is a portion formed in a shape extending from an exhaust end portion of the horizontal portion 610Bb to an exhaust port of the back portion of the housing 10, which is an exhaust destination. A discharge port 612B is provided at an end portion of the discharge portion 610Bc. A filter (not shown) that collects and removes dust and the like is installed in the discharge portion 610Bc.

The suction port 611B is provided at a portion of a lower surface portion of the horizontal portion 610Bb of the duct body 610B facing the upper surface portion of the fixing housing 52. The suction port 611B is formed as a substantially rectangular opening that extends to be long along the depth direction (−Z) of the fixing housing 52.

The discharge port 612B is disposed in a state of being connected to the exhaust port (not shown) provided in the back portion or the like of the housing 10 of the image forming apparatus 1. The discharge port 612B is formed as an opening that is formed at an end portion of the discharge portion 610Bc of the duct body 610B to have a rectangular shape or the like.

The second fan 68B is a blower that generates a force for causing air to be sucked into the second duct 61B and causing the sucked air to flow.

The second fan 68B is installed, for example, in a middle portion of the discharge portion 610Bc of the duct body 610B. A fan identical to the first fan 68A is used as the second fan 68B, but the second fan 68B may be a fan different from the first fan 68A.

Exhaust using the exhaust device 60 is performed as follows.

In the exhaust device 60, the first fan 68A and the second fan 68B start up in a case where an operation, such as the image forming operation, is performed.

Accordingly, a force for causing air to be sucked into the hollow of each of the duct bodies 610A and 610B and causing the sucked air to flow is generated in the first duct 61A and the second duct 61B.

At this time, the first duct 61A sucks a part of the air Ae, which is present on the outlet side of the passage portion FN in the fixing housing 52, from the suction port 611A.

The air Ae sucked into the first duct 61A flows upward through the standing portion 610Aa. After that, the air Ae passes through the horizontal portion 610Ab and the discharge portion 610Ac in this order and is finally discharged to the outside from the discharge port 612A. The flow of the air Ae at this time is as illustrated by broken lines with arrows in FIG. 2, respectively.

Further, at this time, the second duct 61B sucks a part of the air At, which is present on the upper side in the fixing housing 52, from the suction port 611B.

The air At sucked into the second duct 61B flows through the horizontal portion 610Bb. After that, the air At is finally discharged from the discharge port 612B via the discharge portion 610Bc. The flow of the air At at this time is as illustrated by a broken line with an arrow in FIG. 2.

The exhaust device 60 can discharge high-temperature air (hot air), which is generated inside the fixing housing 52 of the fixing device 51, to the outside.

Accordingly, an excessive increase in the temperatures of the fixing device 51 and a peripheral portion thereof during the operation of the fixing device 51 is suppressed, so that the fixing device 51 and the peripheral portion thereof are maintained in an appropriate temperature environment.

### Problems Occurring in Fixing System

Incidentally, the following problems caused by the exhaust device 60 may occur in the fixing system 5 forming the fixing unit 50.

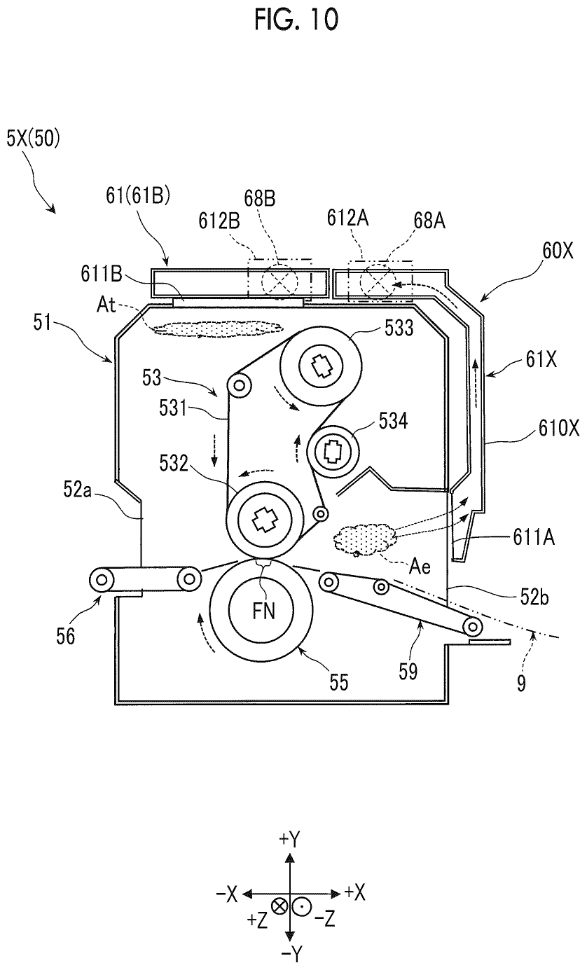

Here, the problems will be described on the basis of a fixing system 5X of a comparative example illustrated in FIG. 10.

The fixing system 5X has a configuration identical to the configuration of the fixing system 5 according to the first exemplary embodiment, except that an exhaust device 60X for comparison is applied.

The exhaust device 60X for comparison is different from the exhaust device 60 of the first exemplary embodiment in the following points. That is, the exhaust device 60X is different from the exhaust device 60 in that a first duct 61X not provided with an opening portion 63, a protruding portion 64, and a collection portion 65, to be described later is employed.

The first duct 61X is a duct that includes a suction port 611A, a discharge port 612A, and a duct body 610X connecting the suction port 611A and the discharge port 612A.

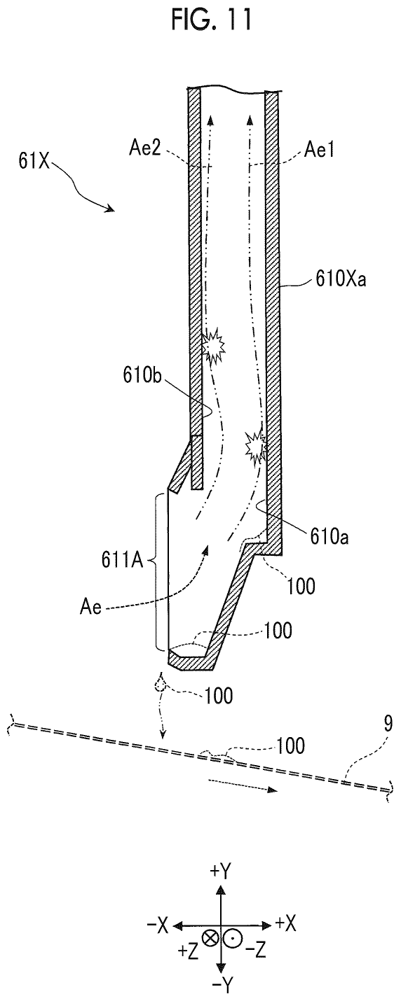

In the fixing system 5X of the comparative example, unnecessary matter 100 is generated inside the first duct 61X of the exhaust device 60X as illustrated in FIG. 11. The unnecessary matter 100 is likely to be generated inside a standing portion 610Xa of the first duct 61X.

In the fixing system 5X, a part of the unnecessary matter 100 may fall down from the suction port 611A and adhere to a recording medium 9.

At this time, a part of air Ae present on an outlet side of a passage portion FN inside the fixing housing 52 is sucked into the first duct 61X.

For example, components such as wax included in the toner of a toner image are volatilized due to the heating of the passage portion FN and are included in the air Ae. The volatilized components are present, for example, as oil mist.

Ae1 indicated by a broken line with an arrow in FIG. 11 denotes airflow of the air Ae that flows in contact with a first inner wall surface 610a of the first duct 61X. Ae2 indicated by a broken line with an arrow in FIG. 11 denotes airflow of the air Ae that flows in contact with a second inner wall surface 610b of the first duct 61X.

The first inner wall surface 610a is an inner wall surface that is relatively far from the fixing housing 52. The second inner wall surface 610b is an inner wall surface that is relatively close to the fixing housing 52. Reference numeral 610c shown in FIG. 11 or the like denotes an inner wall surface on a back side.

The unnecessary matter 100 is matter that is aggregated in a case where a part of the air Ae sucked into and moved inside the first duct 61X comes into contact with the inner wall surface of the first duct 61X. The unnecessary matter 100 is generated, for example, in a case where the oil mist adheres to the inner wall surface.

Further, the unnecessary matter 100 adheres to a portion of the first duct 61X, such as the inner wall surface, increases, and is then moved to hang down and fall.

The unnecessary matter 100 at this time may fall down on the recording medium 9 which has passed through the passage portion FN and to which toner images have been fixed. In this case, the recording medium 9 to which the toner images have been fixed is contaminated due to the adhesion of the unnecessary matter 100, which causes deterioration in image quality.

For example, in a case where a fixing temperature is increased with an increase in a driving speed from a viewpoint of improving the productivity of an image forming operation, the generation of the unnecessary matter 100 is also increased. As a result, the falling of the unnecessary matter 100 is likely to occur.

### Details of Exhaust Device

Therefore, as shown in FIGS. 2 to 4 and the like, a duct that includes at least an opening portion 63, a protruding portion 64, and a collection portion 65 is employed as the first duct 61A in the fixing system 5 according to the first exemplary embodiment.

Among these, the opening portion 63 is an opening that is provided at a position in the middle of the standing portion 610Aa of the first duct 61A and takes in air from the outside of the duct body 610A.

The outside of the duct body 610 is an outside opposite to the fixing housing 52 and is also an outside near the opening portion 63. The standing portion 610Aa is a duct portion of the duct body 610 that allows air to flow upward.

The opening portion 63 is provided in a first side surface portion of the standing portion 610Aa of the first duct 61A that is relatively far from the fixing housing 52. The first side surface portion is also a side surface portion facing a second side surface portion that is provided with the suction port 611A.

The opening portion 63 of the first exemplary embodiment is provided as a long and narrow rectangular opening along the depth direction (−Z) of the first side surface portion. For this reason, the opening portion 63 includes an upper side 63a and a lower side 63b that extend substantially in parallel to each other along the depth direction (−Z).

Further, the opening portion 63 is provided such that a height H1, which is an opening dimension in a vertical direction, is a predetermined dimension. The height H1 is set to, for example, a dimension within a range of 1 to 3 cm.

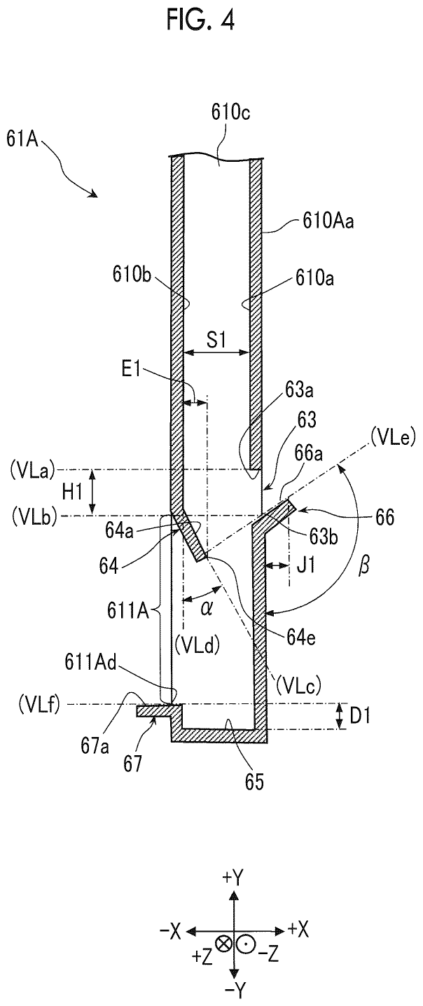

Furthermore, the opening portion 63 is provided to have, for example, a height that allows an imaginary horizontal line VLb passing through the lower side 63b to overlap with a part of the protruding portion 64. Reference character VLa shown in FIG. 4 denotes an imaginary horizontal line passing through the upper side 63a of the opening portion 63.

In addition, the opening portion 63 is provided in a lower half portion of the standing portion 610Aa. The opening portion 63 is provided in the standing portion 610Aa at a position close to the suction port 611A.

Next, the protruding portion 64 is a portion that protrudes into the duct body 610A from an inner wall surface portion facing the opening portion 63.

The inner wall surface facing the opening portion 63 is the second inner wall surface 610b, which is relatively close to the fixing housing 52, of inner wall surfaces of the standing portion 610Aa.

The protruding portion 64 is provided on the second inner wall surface 610b of the inner wall surfaces of the standing portion 610Aa of the first duct 61A. The second inner wall surface 610b is also an inner wall surface facing the first inner wall surface 610a, which is relatively far from the fixing housing 52, of the inner wall surfaces of the standing portion 610Aa.

The protruding portion 64 of the first exemplary embodiment is provided as a plate-like member that is formed in a long and narrow rectangular shape along the depth direction (−Z) of the second inner wall surface 610b. The plate-like member may be a member that is formed in the shape of a plate having an upper surface 64a and a lower surface.

Further, the protruding portion 64 consisting of the plate-like member is provided such that the upper surface 64a is an inclined surface forming an angle α as a predetermined angle with respect to an imaginary extension line VLd extending along the second inner wall surface 610b.

It is preferable that the angle α is, for example, less than 90 degrees. In a case where the angle α is 90 degrees or more, the unnecessary matter 100 is unnecessarily accumulated on the upper surface 64a of the protruding portion 64.

Furthermore, the protruding portion 64 consisting of a plate-like member is provided such that a protruding length E1 of the protruding portion 64 from the second inner wall surface 610b is a predetermined dimension.

The protruding length E1 may be, for example, a value in a range of ⅓ or more and ⅔ or less of an interval S1 between the first inner wall surface 610a and the second inner wall surface 610b of the standing portion 610Aa.

In a case where the protruding length E1 is a value of less than ⅓ of the interval S1, the intentional aggregation of the unnecessary matter is less likely to occur. On the contrary, in a case where the protruding length E1 is a value exceeding ⅔ of the interval S1, an internal space of the standing portion 610Aa is narrowed by the protruding portion 64, so that the air Ae cannot be efficiently sucked.

In addition, the protruding portion 64 may be provided such that, for example, the upper surface 64a is a surface facing the opening portion 63.

Further, for example, the protruding portion 64 may be provided to protrude from a height position lower than a height (VLb) of the lower side 63b of the opening portion 63.

Furthermore, for example, the protruding portion 64 may be provided on the lower half portion of the standing portion 610Aa at a position close to the suction port 611A.

Next, the collection portion 65 is a portion that collects the unnecessary matter 100 mainly generated inside the standing portion 610Aa of the duct body 610A and falling down. For example, the generation of the unnecessary matter is due to aggregation.

The collection portion 65 is provided at a position below the protruding portion 64.

The collection portion 65 of the first exemplary embodiment is provided in a recessed shape below the suction port 611A as shown in FIG. 4.

Further, the collection portion 65 is provided such that a depth D1 of the collection portion 65 from a lower end 611Ad of the suction port 611A is a predetermined dimension. The depth D1 is set to a dimension that allows unnecessary matter, which is to be generated, to be sufficiently stored without leaking out.

Furthermore, the collection portion 65 is provided to be in a positional relationship in which at least a distal end (lower end) 64e of the protruding portion 64 is present immediately above the collection portion 65.

Further, the opening portion 63 of the first exemplary embodiment is provided with an introduction portion 66 as shown in FIG. 4.

The introduction portion 66 is a portion that guides air outside the standing portion 610Aa of the first duct 61A to introduce the air into the standing portion 610Aa at a predetermined angle with respect to the inside of the standing portion 610Aa. The predetermined angle corresponds to a direction orthogonal to the first inner wall surface 610a or a direction obliquely downward with respect to the inside of the standing portion 610Aa.

The introduction portion 66 of the first exemplary embodiment is provided as a plate-like member that protrudes to the outside of the standing portion 610Aa from the lower side 63b of the opening portion 63. The plate-like member includes an upper surface 66a that intersects with the lower side 63b of the opening portion 63.

The introduction portion 66 consisting of the plate-like member is provided such that the upper surface 66a is an inclined surface forming an angle β as a predetermined angle with respect to an outer surface of the first side surface portion.

It is preferable that the angle β is, for example, 90 degrees or more. In a case where the angle β is less than 90 degrees, air flowing in from the opening portion 63 cannot be made to collide with and to be disturbed by the flow of the air Ae sucked in from the suction port 611A.

Further, the introduction portion 66 is provided such that a protruding length J1 of the upper surface 66a protruding from the outer surface of the first side surface portion is a predetermined value. The protruding length J1 is set from a viewpoint of obtaining a function of guiding and introducing outside air at a predetermined angle. It is preferable that the protruding length J1 is, for example, 2 cm or more.

In addition, the introduction portion 66 is provided in a positional relationship in which an imaginary passing line VLe passing along the upper surface 66a intersects with a part of the protruding portion 64.

Further, the collection portion 65 is provided with an inlet plate 67 as shown in FIG. 4.

The inlet plate 67 is a plate-like portion that extends outward in a horizontal direction from a boundary portion with the suction port 611A to form a lower portion of the suction port 611A.

The inlet plate 67 of the first exemplary embodiment is provided in a state of protruding from the lower end 611Ad of the suction port 611A in an outward direction that is substantially orthogonal to the suction port 611A and away from the suction port 611A.

A one-dot chain line denoted by reference character VLf shown in FIG. 4 is an imaginary passing line that passes through the lower end 611Ad of the suction port 611A and extends along an upper surface 67a of the inlet plate 67.

### Action of Exhaust Device of Fixing System

The fixing system 5 according to the first exemplary embodiment is in a state described below in the first duct 61A during the operation of the exhaust device 60.

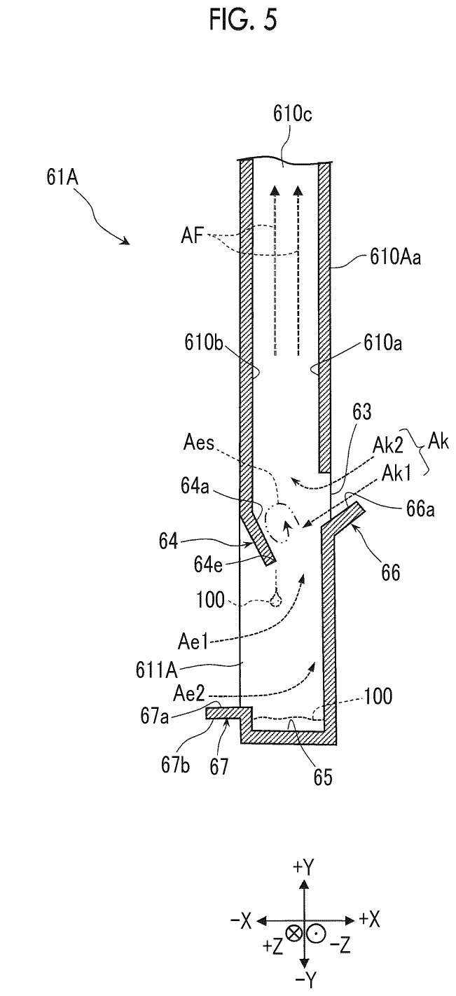

In the first duct 61A, a force for causing air to be sucked into the duct and causing the sucked air to flow is generated by the operation of the first fan 68A. The flowing force at this time is a suction force and appears as airflow AF as illustrated in FIG. 5.

In the first duct 61A, a part of the air Ae present on the outlet side of the passage portion FN is sucked in from the suction port 611A by this flowing force. Hereinafter, a part of the air Ae will be referred to as air Ae1. The sucked air Ae1 flows upward through the standing portion 610Aa of the first duct 61A.

Further, in the first duct 61A, air Ak outside the first duct 61A is taken in from the opening portion 63 by the flowing force.

The air Ak at this time includes partial air Ak1 that flows substantially along the upper surface 66a of the introduction portion 66 consisting of an inclined surface as illustrated in FIG. 5. This partial air Ak1 is likely to travel toward the protruding portion 64 positioned at a travel destination thereof.

Further, the air Ak at this time also includes partial air Ak2 that flows upward immediately after passing through the opening portion 63.

For this reason, the air Ae1 collides with the air Ak1 and the air Ak2 taken in from the opening portion 63 while flowing upward along the standing portion 610Aa. In other words, the air Ak1 and the air Ak2 taken in from the opening portion 63 collide with the air Ae1 sucked in from the suction port 611A. Since the opening portion 63 is provided at a position close to the suction port 611A of the standing portion 610Aa, the collision at this time occurs at an early stage after the air Ae1 passes through the suction port 611A.

Due to this collision, the air Ae1 is in a state of being temporarily retained while circulating inside the duct as illustrated by a two-dot chain line Aes with an arrow in FIG. 5. The air Ae1 at this time is retained to be pressed against the protruding portion 64 of the standing portion 610Aa or the second inner wall surface 610b provided above the protruding portion 64. The retention of the air Ae1 at this time occurs at a position close to the suction port 611A since the protruding portion 64 is provided at a position adjacent to and close to the suction port 611A of the standing portion 610Aa.

Moreover, in a case where the retained air Ae1 contains a component such as wax, the retained air Ae1 is likely to be in contact with the protruding portion 64 or the second inner wall surface 610b provided above the protruding portion 64. For this reason, unnecessary matter 100 caused by the air Ae1 is likely to be generated on the protruding portion 64 or the second inner wall surface 610b provided above the protruding portion 64.

As a result, in the first duct 61A, unnecessary matter 100 adheres to and aggregates on the protruding portion 64 of the standing portion 610Aa or the second inner wall surface 610b provided above the protruding portion 64.

Then, the unnecessary matter 100 moves along the upper surface 64a, which is a downward inclined surface of the protruding portion 64, and falls from the distal end 64e, as illustrated in FIG. 5.

Further, the unnecessary matter 100 having fallen falls into the collection portion 65 provided almost immediately below the protruding portion 64, and is collected. The unnecessary matter 100 at this time is stored in the collection portion 65 having a recessed shape and does not overflow.

Therefore, in the fixing system 5, the unnecessary matter 100 is prevented from falling onto the recording medium 9, which passes through the passage portion FN of the fixing device 51, from the suction port 611A of the first duct 61A of the exhaust device 60.

Accordingly, in the image forming apparatus 1 including the fixing system 5, the unnecessary matter 100 does not fall onto the recording medium 9 to which the toner images have been fixed and does not contaminate the recording medium 9. Further, the deterioration of image quality, which is caused by the adhesion of the unnecessary matter 100, also does not occur.

Furthermore, in the fixing system 5, the opening portion 63 of the first duct 61A is provided with the introduction portion 66.

Accordingly, in the fixing system 5, the opening portion 63 easily takes in the air Ak, which is present outside the standing portion 610Aa of the first duct 61A, along a predetermined direction as compared to a case where the opening portion 63 does not include the introduction portion 66.

As a result, in the fixing system 5, the unnecessary matter 100 is likely to be generated and collected in the standing portion 610Aa of the first duct 61A even as compared to the case of a configuration in which the introduction portion 66 allows air to travel along the upward direction with respect to the inside of the duct and introduces the air into the duct. This is promoted by the intake of the air Ak along a predetermined direction.

Further, in the fixing system 5, the protruding portion 64 of the first duct 61A is provided at a position below the opening portion 63.

Accordingly, in the fixing system 5, the outside air Ak taken in from the opening portion 63 is likely to flow toward the protruding portion 64 provided below the opening portion 63.

As a result, in the fixing system 5, the unnecessary matter 100 is likely to be generated on the protruding portion 64 as compared to a case where the protruding portion 64 is provided at a position above the opening portion 63. Moreover, the unnecessary matter 100 generated on the protruding portion 64 moves along the upper surface 64a, which is the downward inclined surface of the protruding portion 64, falls into the collection portion 65 provided below the protruding portion 64, and is then collected.

In addition, in the fixing system 5, the collection portion 65 of the first duct 61A is provided with the inlet plate 67.

Accordingly, a part Ae2 of the air Ae sucked in from the suction port 611A is sucked in a state of being guided to the upper surface 67a of the horizontal inlet plate 67 as illustrated in FIG. 5.

As a result, the generation of unnecessary matter 100, which is caused by contact between a part Ae2 of the air Ae sucked in from the suction port 611A and a lower surface 67b or the upper surface 67a of the inlet plate 67 extending obliquely upward or obliquely downward, is suppressed in the fixing system 5. Further, the falling of the unnecessary matter 100 onto the lower surface 67b or the upper surface 67a of the inlet plate 67 without being stored in the collection portion 65 is also suppressed.

### Second Exemplary Embodiment

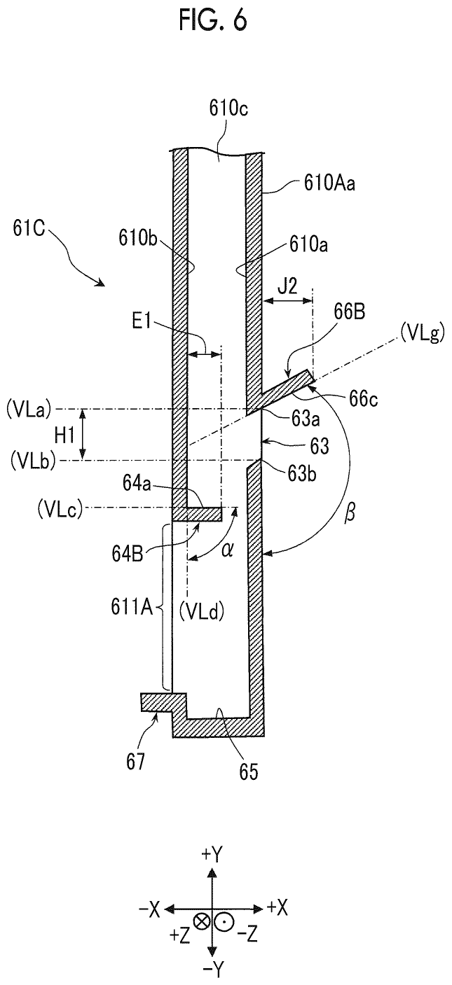

FIG. 6 is a schematic cross-sectional view of a major portion of an exhaust device of a fixing system according to a second exemplary embodiment.

The fixing system according to the second exemplary embodiment is different from the fixing system 5 (see FIG. 2 and the like) according to the first exemplary embodiment only in that the first duct 61A of the exhaust device is changed to a first duct 61C.

The first duct 61C of the second exemplary embodiment has a configuration identical to the configuration of the first duct 61A of the first exemplary embodiment, except that the protruding portion 64 is changed to a protruding portion 64B and the introduction portion 66 is changed to an introduction portion 66B.

An angle α between an upper surface 64a of the protruding portion 64B and an imaginary extension line VLd extending along the second inner wall surface 610b is changed to an angle larger than the angle α of the first exemplary embodiment. The angle α of the second exemplary embodiment is changed to an angle substantially close to 90 degrees (for example, 88 degrees).

Further, a protruding length E1 of the protruding portion 64B from the second inner wall surface 610b is a value substantially equal to the value of the protruding length E1 of the first exemplary embodiment.

Furthermore, the protruding portion 64B is provided at a position below the opening portion 63.

The introduction portion 66B is provided as a plate-like member that protrudes obliquely upward from the upper side 63a of the opening portion 63 to the outside of the standing portion 610Aa.

An angle β between a lower surface 66c of the introduction portion 66B and the outer surface of the first side surface portion is set to an angle substantially equal to the angle β of the first exemplary embodiment.

Further, a protruding length J2 of the lower surface 66c of the introduction portion 66B protruding from the outer surface of the first side surface portion is set to a value substantially equal to the protruding length J1 of the first exemplary embodiment.

In addition, the introduction portion 66B is provided in a positional relationship in which an imaginary passing line VLg passing along the lower surface 66c intersects with a portion of the second inner wall surface 610b positioned above the protruding portion 64B.

An upper end of the suction port 611A of the first duct 61C starts from a lower surface of the protruding portion 64B.

Further, an inclined surface that is inclined downward from the lower side 63b of the opening portion 63 toward the inside of the duct is formed in the first duct 61C. The inclined surface has an inclination angle substantially equal to the inclination angle of the lower surface 66c of the introduction portion 66B.

### Action of First Duct of Second Exemplary Embodiment

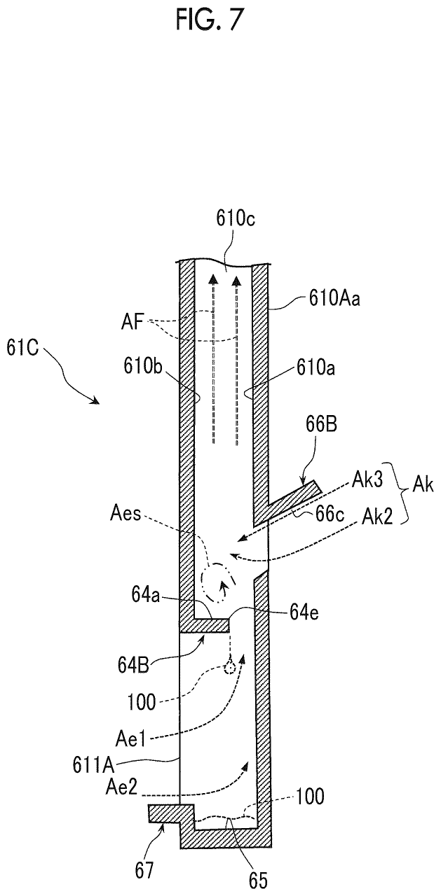

A flowing force identical to the flowing force in the case of the first duct 61A of the first exemplary embodiment is generated in the first duct 61C by the operation of the first fan 68A. The flowing force at this time also appears as airflow AF as illustrated in FIG. 7.

Even in the first duct 61C, first, air Ae1, which is a part of air Ae present on the outlet side of the passage portion FN, is sucked in from the suction port 611A by this flowing force. Further, the sucked air Ae1 flows upward through the standing portion 610Aa of the first duct 61C.

Furthermore, even in the first duct 61C, air Ak outside the first duct 61C is taken in from the opening portion 63 by the flowing force.

The air Ak at this time includes partial air Ak3 that flows substantially along the lower surface 66c of the introduction portion 66B consisting of an inclined surface as illustrated in FIG. 7. This partial air Ak3 is likely to travel toward a portion of the second inner wall surface 610b of the standing portion 610Aa that is positioned slightly above the protruding portion 64B.

Further, the air Ak at this time also includes partial air Ak2 that flows upward immediately after passing through the opening portion 63.

For this reason, the air Ae1 collides with the air Ak2 and the air Ak3 taken in from the opening portion 63 while flowing upward along the standing portion 610Aa. In other words, the air Ak2 and the air Ak3 taken in from the opening portion 63 collide with the air Ae1 sucked in from the suction port 611A.

Due to this collision, the air Ae1 is in a state of being temporarily retained while circulating inside the duct as illustrated by a two-dot chain line Aes with an arrow in FIG. 7. The air Ae1 at this time is also retained to be pressed against the protruding portion 64B of the standing portion 610Aa or the second inner wall surface 610b provided above the protruding portion 64B.

Moreover, in a case where the retained air Ae1 contains a component such as wax, the retained air Ae1 is in contact with the protruding portion 64B or the second inner wall surface 610b provided above the protruding portion 64B, so that unnecessary matter 100 is likely to be generated.

As a result, in the first duct 61C, unnecessary matter 100 adheres to and aggregates on the protruding portion 64B of the standing portion 610Aa or the second inner wall surface 610b provided above the protruding portion 64B.

Then, the unnecessary matter 100 moves along the upper surface 64a, which is a slightly downward inclined surface of the protruding portion 64B, and falls down from the distal end 64e, as illustrated in FIG. 7.

Further, the unnecessary matter 100 having fallen falls into the collection portion 65 provided almost immediately below the protruding portion 64B, and is collected.

Therefore, even in the fixing system according to the second exemplary embodiment, the unnecessary matter 100 is prevented from falling onto the recording medium 9, which passes through the passage portion FN of the fixing device 51, from the suction port 611A of the first duct 61C of the exhaust device 60.

### Third Exemplary Embodiment

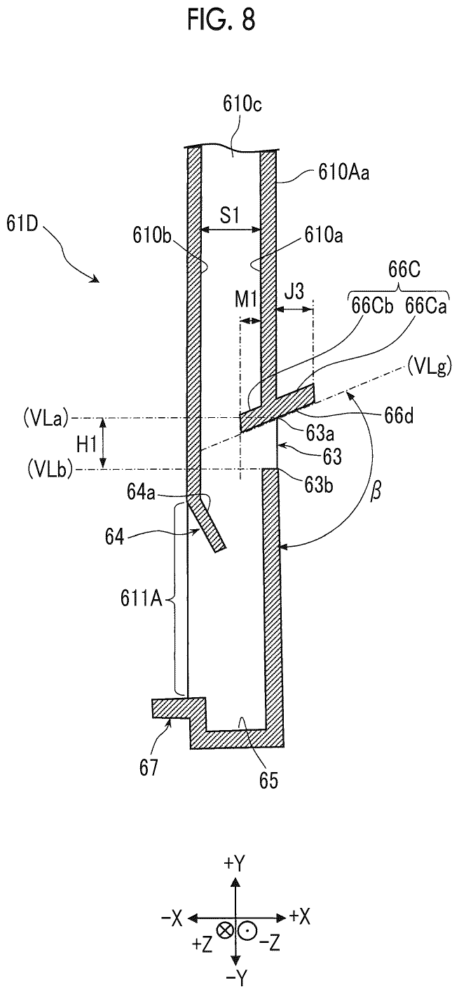

FIG. 8 is a schematic cross-sectional view showing a major portion of an exhaust device of a fixing system according to a third exemplary embodiment.

The fixing system according to the third exemplary embodiment is different from the fixing system 5 (see FIG. 2 and the like) according to the first exemplary embodiment only in that the first duct 61A of the exhaust device 60 is changed to a first duct 61D.

The first duct 61D of the third exemplary embodiment has a configuration identical to the configuration of the first duct 61A of the first exemplary embodiment, except that the introduction portion 66 is changed to an introduction portion 66C.

The introduction portion 66C is provided as a plate-like member that protrudes to both the outside and the inside at the upper side 63a of the opening portion 63. Specifically, the introduction portion 66C includes an outer protruding portion 66Ca and an inner protruding portion 66Cb.

The outer protruding portion 66Ca is a portion that protrudes obliquely upward from the upper side 63a of the opening portion 63 to the outside of the duct. The inner protruding portion 66Cb is a portion that protrudes obliquely downward from the upper side 63a of the opening portion 63 to the inside of the duct.

The introduction portion 66C includes a lower surface 66d common to the outer protruding portion 66Ca and the inner protruding portion 66Cb. The lower surface 66d is a surface that is longer than the lower surface 66c of the introduction portion 66B of the second exemplary embodiment by a length of the inner protruding portion 66Cb since the inner protruding portion 66Cb is present.

An angle β between the lower surface 66d of the introduction portion 66C and the outer surface of the first side surface portion is set to an angle substantially equal to the angle β of the first exemplary embodiment.

A protruding length J3 of the lower surface 66d of the outer protruding portion 66Ca protruding from the outer surface of the first side surface portion is set to a value substantially equal to the protruding length J2 of the introduction portion 66B of the second exemplary embodiment.

Further, a protruding length M1 of the lower surface 66d of the inner protruding portion 66Cb protruding from the first inner wall surface 610a is set to a predetermined value. The protruding length M1 may be set to, for example, a value in a range of ⅓or more and ½ or less of an interval S1 between the first inner wall surface 610a and the second inner wall surface 610b of the standing portion 610Aa.

### Action of First Duct of Third Exemplary Embodiment

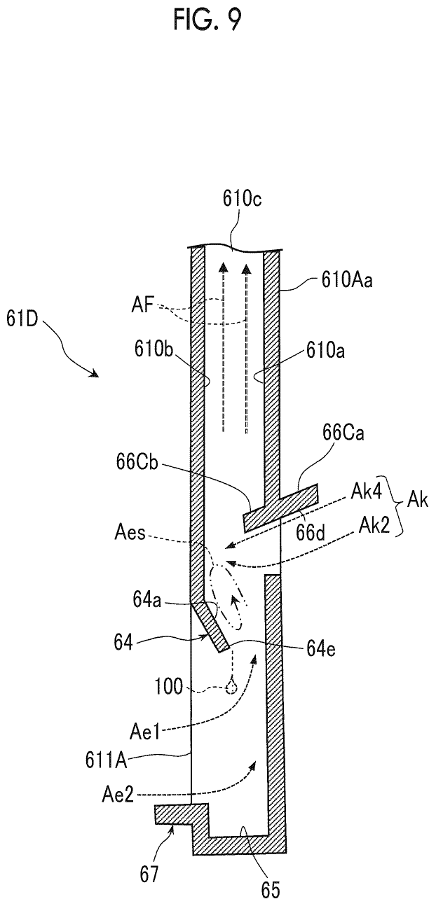

A flowing force identical to the flowing force in the case of the first duct 61A of the first exemplary embodiment is generated in the first duct 61D by the operation of the first fan 68A. The flowing force at this time also appears as airflow AF as illustrated in FIG. 9.

Even in the first duct 61D, first, air Ae1, which is a part of air Ae present on the outlet side of the passage portion FN, is sucked in from the suction port 611A by this flowing force. Further, the sucked air Ae1 flows upward through the standing portion 610Aa of the first duct 61D.

Furthermore, even in the first duct 61D, air Ak outside the first duct 61D is taken in from the opening portion 63 by the flowing force.

The air Ak at this time includes partial air Ak4 that flows substantially along the lower surface 66d of the introduction portion 66C consisting of an inclined surface as illustrated in FIG. 9. This partial air Ak4 is likely to travel toward a portion of the second inner wall surface 610b of the standing portion 610Aa that is positioned slightly above the protruding portion 64. Moreover, as the lower surface 66d of the inner protruding portion 66Cb is provided, the air Ak4 at this time is more likely to travel to the above-described portion of the second inner wall surface 610b than the air Ak3 of the second exemplary embodiment.

Further, the air Ak at this time also includes partial air Ak2 that flows upward immediately after passing through the opening portion 63.

For this reason, the air Ae1 collides with the air Ak2 and the air Ak4 taken in from the opening portion 63 while flowing upward along the standing portion 610Aa. In other words, the air Ak2 and the air Ak4 taken in from the opening portion 63 collide with the air Ae1 sucked in from the suction port 611A.

Since a passage of the duct is narrowed as the inner protruding portion 66Cb of the introduction portion 66C is present in the duct, the collision tends to be stronger.

Due to this collision, the air Ae1 is in a state of being temporarily retained while circulating inside the duct as illustrated by a two-dot chain line Aes with an arrow in FIG. 9. The air Ae1 at this time is also retained to be pressed against the protruding portion 64 of the standing portion 610Aa or the second inner wall surface 610b provided above the protruding portion 64.

Moreover, in a case where the retained air Ae1 contains a component such as wax, the retained air Ae1 is in contact with the protruding portion 64 or the second inner wall surface 610b provided above the protruding portion 64, so that unnecessary matter 100 is likely to be generated.

As a result, in the first duct 61D, unnecessary matter 100 adheres to and aggregates on the protruding portion 64 of the standing portion 610Aa or the second inner wall surface 610b provided above the protruding portion 64.

Then, the unnecessary matter 100 moves along the upper surface 64a, which is a slightly downward inclined surface of the protruding portion 64, and falls from the distal end 64e, as illustrated in FIG. 9.

Further, the unnecessary matter 100 having fallen falls into the collection portion 65 provided almost immediately below the protruding portion 64B, and is collected.

Therefore, even in the fixing system according to the third exemplary embodiment, the unnecessary matter 100 is prevented from falling onto the recording medium 9, which passes through the passage portion FN of the fixing device 51, from the suction port 611A of the first duct 61D of the exhaust device 60.

### Modification Examples

The present invention is not limited to the configurations illustrated as the first to third exemplary embodiments. That is, the present invention can have various modifications or alterations without changing the gist of each of inventions described in claims.

The present invention also includes, for example, modification examples to be described below.

The fixing system 5 is not limited to a fixing system that is used in a state of being disposed inside the housing 10 of the image forming apparatus 1. For example, the fixing system 5 may be a fixing system that is used to be connected in a state of being disposed outside the housing 10.

In the fixing device 51, a roller-shaped rotating body including a heating unit may be applied as the first rotating body 53.

The second duct 61B may be omitted from the exhaust device 60.

The angle α of the upper surface 64a of the protruding portion 64B of the second exemplary embodiment may be set to 90 degrees. The angle α at this time is also an angle orthogonal to the second inner wall surface 610b of the standing portion 610Aa.

Further, the angle β of the upper surface 66a of the introduction portion 66, the angle β of the lower surface 66c of the introduction portion 66B, and the angle β of the lower surface 66d of the introduction portion 66C may also be set to 90 degrees. Each of the angles β at this time is also an angle orthogonal to the outer or inner surface of the first side surface portion of the standing portion 610Aa.

In the first exemplary embodiment, a unit including the imaging section 20 and the intermediate transfer section 30 has been exemplified as the image forming unit 2 of the image forming apparatus 1.

However, the configuration of the image forming unit 2 of the image forming apparatus 1 according to the exemplary embodiment of the present invention is not particularly limited, and the image forming apparatus may be an image forming apparatus that requires the fixing unit 50 consisting of the fixing system 5.

The imaging section 20 is not limited to an imaging section that consists of four imaging units 20A, 20B, 20C, and 20D. Further, the number of imaging units may be any number other than four or may be one. Furthermore, the image forming unit 2 may not include the intermediate transfer section 30.

Alternatively, the upper housing 10A and the lower housing 10B of the image forming apparatus 1 may be independent separate bodies and may be connected to each other during use.

Further, the medium feed section 40 of the image forming apparatus 1 may be a medium feed device that is separate from the image forming apparatus 1 and is connected to the image forming apparatus 1 in a case where the medium feed device is used.

Furthermore, the discharge storage part of the image forming apparatus 1 may be a post-processing device that also has a function of performing predetermined post-processing on the recording medium 9.

### Supplementary Note

(((1)))

A fixing system comprising:
a fixing device including a first rotating body that is heated by a heating unit and is rotated, and a second rotating body that is rotated while being in contact with an outer peripheral surface of the first rotating body to form a passage portion through which a recording medium on which a toner image is formed is to pass; and
an exhaust device including a duct that allows a part of air present on an outlet side of the passage portion to flow such that the air is sucked in from a suction port, flows upward at least once, and is then discharged to an outside from a discharge port, and a fan that generates a force for causing air to be sucked into the duct and causing the sucked air to flow,
wherein the duct includes an opening portion that is provided at a position in a middle of a portion of the duct allowing the air to flow upward and takes in air from the outside of the duct, a protruding portion that protrudes into the duct from an inner wall surface portion facing the opening portion, and a collection portion that is provided at a position below the protruding portion and collects unnecessary matter generated inside the duct and falling down.
(((2)))

The fixing system according to claim 1))),
wherein the opening portion includes an introduction portion that allows air to travel along a direction orthogonal to an inside of the duct or a direction obliquely downward with respect to the inside of the duct and introduces the air into the duct.
(((3)))

The fixing system according to (((1))) or (((2))),
wherein the opening portion is provided at a position close to the suction port.
(((4)))

The fixing system according to any one of (((1))) to (((3))),
wherein the protruding portion is formed of a plate-like member that protrudes to extend in an orthogonal direction or an obliquely downward direction inside the duct.
(((5))

The fixing system according to any one of (((1))) to (((4))),
wherein the protruding portion is provided at a position below the opening portion.
(((6)))

The fixing system according to any one of (((1))) to (((5))),
wherein the collection portion is provided in a recessed shape below the suction port.
(((7)))

The fixing system according to (((6))),
wherein the collection portion is provided with an inlet plate that extends in a horizontal direction from a boundary portion with the suction port to form a lower portion of the suction port.
(((8)))

An image forming apparatus comprising:
an image forming unit that forms a toner image on a recording medium; and
a fixing unit that heats the toner image formed by the image forming unit to fix the toner image to the recording medium,
wherein the fixing unit is formed of the fixing system according to any one of (((1))) to (((7))).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing system comprising:
a fixing device including a first rotating body that is heated by a heating unit and is rotated, and a second rotating body that is rotated while being in contact with an outer peripheral surface of the first rotating body to form a passage portion through which a recording medium on which a toner image is formed is to pass; and
an exhaust device including a duct that allows a part of air present on an outlet side of the passage portion to flow such that the air is sucked in from a suction port, flows upward at least once, and is then discharged to an outside from a discharge port, and a fan that generates a force for causing air to be sucked into the duct and causing the sucked air to flow,
wherein the duct includes an opening portion that is provided at a position in a middle of a portion of the duct allowing the air to flow upward and takes in air from the outside of the duct, a protruding portion that protrudes into the duct from an inner wall surface portion facing the opening portion, and a collection portion that is provided at a position below the protruding portion and collects unnecessary matter generated inside the duct and falling down.

2. The fixing system according to claim 1,
wherein the opening portion includes an introduction portion that allows air to travel along a direction orthogonal to an inside of the duct or a direction obliquely downward with respect to the inside of the duct and introduces the air into the duct.

3. The fixing system according to claim 2,
wherein the opening portion is provided at a position close to the suction port.

4. The fixing system according to claim 1,
wherein the protruding portion is formed of a plate-like member that protrudes to extend in an orthogonal direction or an obliquely downward direction inside the duct.

5. The fixing system according to claim 4,
wherein the protruding portion is provided at a position below the opening portion.

6. The fixing system according to claim 1,
wherein the collection portion is provided in a recessed shape below the suction port.

7. The fixing system according to claim 6,
wherein the collection portion is provided with an inlet plate that extends in a horizontal direction from a boundary portion with the suction port to form a lower portion of the suction port.

8. An image forming apparatus comprising:
an image forming unit that forms a toner image on a recording medium; and
a fixing unit that heats the toner image formed by the image forming unit to fix the toner image to the recording medium,
wherein the fixing unit is formed of the fixing system according to claim 1.

9. An image forming apparatus comprising:
an image forming unit that forms a toner image on a recording medium; and
a fixing unit that heats the toner image formed by the image forming unit to fix the toner image to the recording medium,
wherein the fixing unit is formed of the fixing system according to claim 2.

10. An image forming apparatus comprising:
an image forming unit that forms a toner image on a recording medium; and
a fixing unit that heats the toner image formed by the image forming unit to fix the toner image to the recording medium,
wherein the fixing unit is formed of the fixing system according to claim 3.

11. An image forming apparatus comprising:
an image forming unit that forms a toner image on a recording medium; and
a fixing unit that heats the toner image formed by the image forming unit to fix the toner image to the recording medium,
wherein the fixing unit is formed of the fixing system according to claim 4.

12. An image forming apparatus comprising:
an image forming unit that forms a toner image on a recording medium; and
a fixing unit that heats the toner image formed by the image forming unit to fix the toner image to the recording medium,
wherein the fixing unit is formed of the fixing system according to claim 5.

13. An image forming apparatus comprising:
an image forming unit that forms a toner image on a recording medium; and
a fixing unit that heats the toner image formed by the image forming unit to fix the toner image to the recording medium,
wherein the fixing unit is formed of the fixing system according to claim 6.

14. An image forming apparatus comprising:
an image forming unit that forms a toner image on a recording medium; and
a fixing unit that heats the toner image formed by the image forming unit to fix the toner image to the recording medium,
wherein the fixing unit is formed of the fixing system according to claim 7.
